(19) United States
(12) Patent Application Publication
(10) Pub. No.: US 2008/0055226 A1
(43) Pub. Date: Mar. 6, 2008

(54) DAC AND SOURCE DRIVER USING THE SAME, AND METHOD FOR DRIVING A DISPLAY DEVICE

(75) Inventors: Jiao-Lin Huang, Taoyuan County (TW); Liang-Hua Yeh, Taipei County (TW); Ho-Ming Su, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/468,306

(22) Filed: Aug. 30, 2006

(51) Int. Cl. G09G 3/36

(52) U.S. Cl. 345/100

(57) ABSTRACT

A DAC and a source driver using the same, and a driving method for a display device are provided. The DAC comprises a positive polarity resistor string and a negative polarity resistor string. The resistance of each resistor of the positive polarity resistor string is determined based on positive polarity driving voltages. The resistance of each resistor of the negative polarity resistor string is determined based on negative polarity driving voltages. So, the positive and negative polarity driving voltages, which are used for driving the display device, are in symmetric.

### BACKGROUND OF THE INVENTION

1. Field of Invention

The present invention relates to a DAC, a source driver using the same and a driving method for a display device. More particularly, the present invention relates to DAC and a source driver using the same which generate symmetric positive or negative polarity driving voltages, and a driving method for a display device.

2. Description of Related Art

In recent dates, display devices play important roles in people lives. The display devices are at least classified as LCD (liquid crystal display), PDP (plasma display panel), OLED (organic light emitting display), FED (field emission display) and etc. LCD display devices, featured with size compact, low power consumption, low radiation, becomes a mainstream.

In general, in LCD display devices, driving voltages are applied to liquid crystal modules (or pixels) for display. However, the relationship between the driving voltage and the transmittance rate of the liquid crystal modules is not linear, instead in a gamma curve. A gamma correction is performed for making a linear relationship between the gray scale signal and the transmittance rate of the liquid crystal modules.

In LCD display device, the driving voltages are generated by a voltage divider made of series connected resistors. The resistors for generating the driving voltages in LCD display device are disposed in a digital-to-analog converter (DAC). The DAC is a part of a source driving circuit which is used for driving a LCD panel in the LCD display device.

How to calculate the resistance value of the series connected resistors in the DAC is described as following. First, each liquid crystal voltage in each gradient is obtained from a voltage-to-transmittance rate of the liquid crystal modules and a gamma curve. Then, an extrapolation or interpolation approximation is used for estimating positive polarity driving voltages and negative polarity driving voltages from external reference voltages. A voltage difference between any two consecutive estimated driving voltages is used for calculating the resistance value of the resistors. More specially, in the following description, positive polarity resistors and negative polarity resistors are used for outputting the positive polarity driving voltages and the negative polarity driving voltages, respectively.

Usually, in the same gradient, the resistance value of the positive polarity resistor is different from that of the negative polarity resistor. So, if the resistance values of the positive polarity resistors, calculated from the estimated positive polarity driving voltages, are set the same as the resistance values of the negative polarity resistors, and the negative polarity resistors are used for outputting the negative polarity driving voltages, then the positive polarity driving voltages and the negative polarity driving voltages are not in symmetric. As shown in FIG. 1A, the actual negative polarity driving voltages are not the same as the ideal negative polarity driving voltages. In FIG. 1A, the x-axis and the y-axis represent the gray scale signal and the driving voltage, respectively.

On the contrary, So, if the resistance values of the negative polarity resistors, calculated from the estimated negative polarity driving voltages, are set the same as the resistance values of the positive polarity resistors, and the positive polarity resistors are used for outputting the negative polarity driving voltages, then the positive polarity driving voltages and the negative polarity driving voltages are not in symmetric. As shown in FIG. 1B, the actual positive polarity driving voltages are not the same as the ideal positive polarity driving voltages. In FIG. 1B, the x-axis and the y-axis represent the gray scale signal and the driving voltage, respectively.

In convention, several external reference voltages are applied for making a better symmetry between the positive polarity driving voltages and the negative polarity driving voltages. But, although the external reference voltages are in symmetric, almost other driving voltages are not in symmetric yet.

### SUMMARY OF THE INVENTION

One of the aspects of the invention is to provide a DAC and a source driving circuit using the same for generating symmetric positive polarity driving voltages and negative polarity driving voltages and improving the Gamma curve.

Another aspect of the invention is to provide a driving method for driving a display device by symmetric positive polarity driving voltages and negative polarity driving voltages.

To at least achieve the above and other aspects, the invention provides a digital-to-analog conversion (DAC) circuit, receiving at least first and second positive polarity reference voltages and first and second negative polarity reference voltages, estimating first to N-th (N being a natural number) positive polarity driving voltages based on the first and second positive polarity reference voltages and estimating first to N-th negative polarity driving voltages based on the first and second negative polarity reference voltages. The DAC circuit comprises: a positive polarity resistor string, having series connected first to (N−1)-th positive polarity resistors, the resistance value of the i-th (1≦i≦N−1) positive polarity resistor being corresponding to a difference between the i-th positive polarity driving voltage and the (i+1)-th positive polarity driving voltage; and a negative polarity resistor string, having series connected first to (N−1)-th negative polarity resistors, the resistance value of the i-th negative polarity resistor being corresponding to a difference between the i-th negative polarity driving voltage and the (i+1)-th negative polarity driving voltage. The resistance value of the i-th positive polarity resistor is different from that of the i-th negative polarity resistor.

If the first positive polarity driving voltage is set as the first positive polarity reference voltage and the second positive polarity driving voltage is set as the second positive polarity reference voltage, the resistance value of the i-th positive polarity resistor is expressed as Rᵢ₊=(Vᵢ₊−V₍ᵢ₊₁₎₊/I₊. Rᵢ₊ refers to the resistance value of the i-th positive polarity resistor, Vᵢ₊ refers to the i-th positive polarity driving voltage, V₍ᵢ₊₁₎₊ refers to the (i+1)-th positive polarity driving voltage and I₊ refers to a current flowing through the positive polarity resistor string.

Further, if the first negative polarity driving voltage is set as the first negative polarity reference voltage and the second negative polarity driving voltage is set as the second negative polarity reference voltage, the resistance value of the i-th negative polarity resistor is expressed as Rᵢ₋=(Vᵢ₋−V₍ᵢ₊₁₎₋/I−. Rᵢ₋ refers to the resistance value of the i-th negative polarity resistor, Vᵢ₋ refers to the i-th negative polarity driving voltage, V₍ᵢ₊₁₎₋ refers to the (i+1)-th negative polarity driving voltage and I− refers to a current flowing through the negative polarity resistor string.

The present invention also provides a source driving circuit for driving a display device, the source driving circuit including: a gray scale signal input unit, receiving a gray scale signal; a digital-to-analog conversion unit, receiving an output signal from the gray scale input unit and converts into one of first to N-th (N being a natural number) positive polarity driving voltages and one of first to N-th negative polarity driving voltages, the DAC circuit estimating the first to N-th positive polarity driving voltages and the first to N-th negative polarity driving voltages based on first and second positive polarity reference voltages and first and second negative polarity reference voltages, respectively, the DAC unit including series connected first to (N−1)-th positive polarity resistors and series connected first to (N−1)-th negative polarity resistors, the i-th (i being a natural number between 1 and N−1) positive polarity resistor being coupled between the i-th positive polarity driving voltage and the (i+1)-th positive polarity driving voltage and the i-th negative polarity resistor being coupled between the i-th negative polarity driving voltage and the (i+1)-th negative polarity driving voltage, the resistance value of the i-th positive polarity resistor being different from that of the i-th negative polarity resistor; and an output unit, receiving one of the first to N-th positive polarity driving voltages and one of the first to N-th negative polarity driving voltages from the DAC circuit.

The present invention also provides a method for driving a display device, comprising steps of: receiving a gray scale signal; estimating first to N-th (N being a natural number) positive polarity driving voltages based on first and second positive polarity reference voltages; estimating first to N-th negative polarity driving voltages based on first and second negative polarity reference voltages; calculating resistance values of first to (N−1)-th positive polarity resistors based on the estimated first to N-th positive polarity driving voltages, the i-th (i being a natural number between 1 and N−1) positive polarity resistor being coupled between the i-th positive polarity driving voltage and the (i+1)-th positive polarity driving voltage; calculating resistance values of first to (N−1)-th negative polarity resistors based on the estimated first to N-th negative polarity driving voltages, the i-th negative polarity resistor being coupled between the i-th negative polarity driving voltage and the (i+1)-th negative polarity driving voltage, the resistance value of the i-th positive polarity resistor being different from that of the i-th negative polarity resistor; and driving the display device based on one of the positive polarity driving voltages or one of the negative polarity driving voltages.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B show the ideal and actual the positive polarity driving voltages and the negative polarity driving voltages in the prior art.

FIG. 2 shows a Gamma curve.

FIG. 3 shows a liquid crystal voltage-to-transmittance rate curve of the liquid crystal modules.

FIG. 4 shows an equivalent circuit of a sub-pixel.

FIG. 5 shows waveforms of a gate voltage V_{G} and a node voltage N1 of FIG. 4 at 0^{th} gradient.

FIG. 6 shows positive polarity resistors and negative polarity resistors according to an embodiment of the present invention.

FIG. 7 shows a block diagram of a source driving circuit according to the embodiment of the present invention.

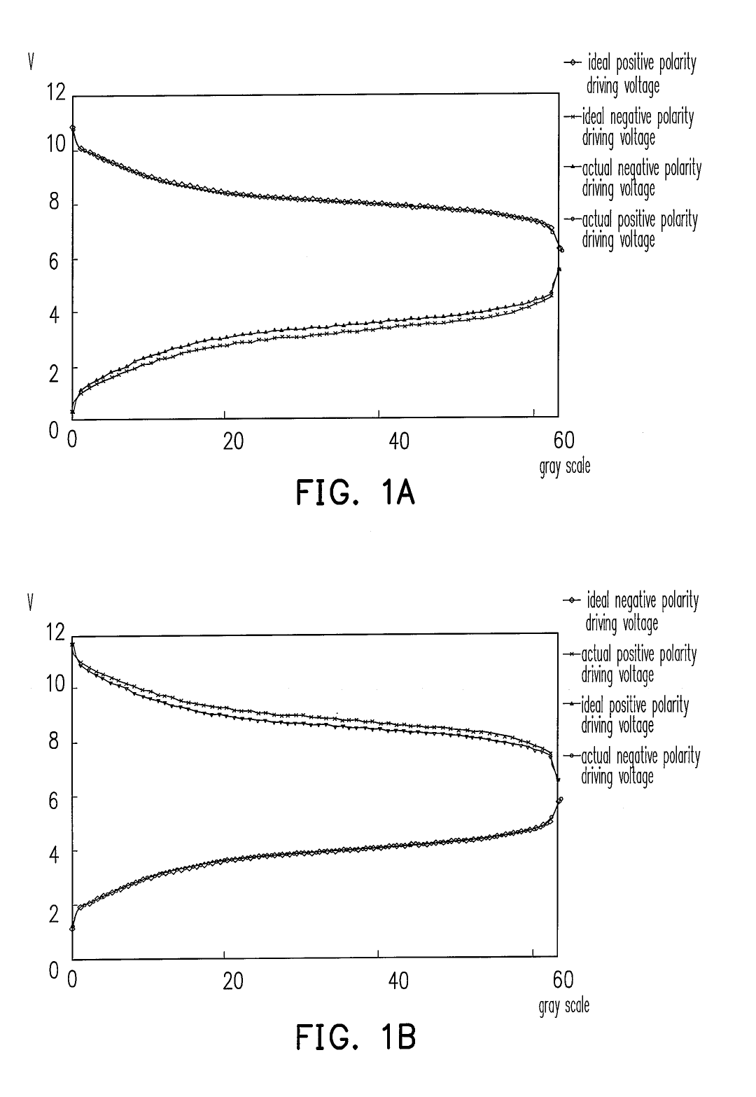

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In an embodiment of the invention, positive polarity resistors have different resistance values from negative polarity resistors for achieving better symmetry between positive polarity driving voltages and negative polarity driving voltages. The resistance values of the positive polarity resistors are calculated from the estimated positive polarity driving voltages and the resistance values of the negative polarity resistors are calculated from the estimated negative polarity driving voltages.

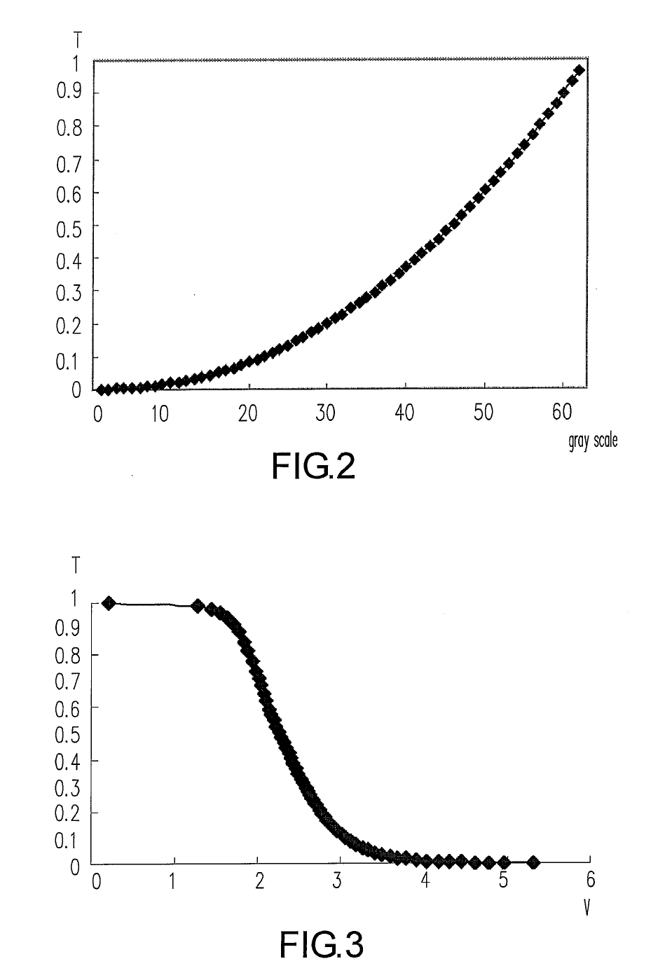

A Gamma curve is established, as shown in FIG. 2. In FIG. 2, the y-axis and the x-axis represent the transmittance rate and the gray scale signal, respectively. From FIG. 2, it is known that the transmittance rate and the gray scale signal are not in a linear relationship. Now, please refer to FIG. 3, which shows a liquid crystal voltage-to-transmittance rate curve of the liquid crystal modules. In FIG. 3, the y-axis and the x-axis represent the transmittance rate of the liquid crystal modules and the liquid crystal voltage in each scale (or each gradient). Liquid crystal voltages of each scale (or each gradient) can be obtained from FIGS. 2 and 3. For example, at the 30^{th} gradient (i.e. if the gray scale signal is 30), the transmittance rate is 0.2 from FIG. 2. Then, the liquid crystal voltage at the 30th gradient is 2.5V, as shown in FIG. 3.

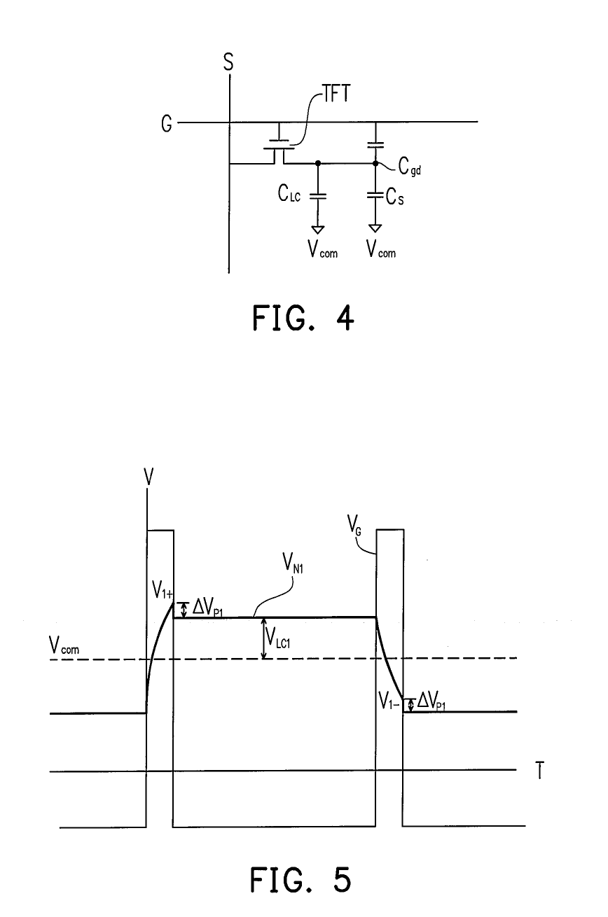

Now please refer to FIG. 4 which shows an equivalent circuit of a sub-pixel. A pixel includes at least 3 sub-pixels for showing three primary colors R, G and B. As shown in FIG. 4, a sub-pixel includes a thin film transistor TFT, a storage capacitor Cs, a liquid crystal capacitor C_{LC} and a parasitic capacitor Cgd. Now, please also refer to FIG. 5 which shows waveforms of a gate voltage V_{G} and a node voltage N1 of FIG. 4 at 0^{th} gradient. When the gate voltage V_{G} is logic high for turning ON the transistor TFT, the storage capacitor Cs is charged to V₁₊. When the gate voltage V_{G} is logic low for turning OFF the transistor TFT, the storage capacitor Cs is discharged for charging the parasitic capacitor Cgd. Therefore, the node voltage N1 has a drop Δ Vp1 from the first positive polarity driving voltage V₁₊. Similarly, after the storage capacitor Cs is charged to V₁₋, the transistor TFT is turned OFF (the gate voltage V_{G} is logic low) and the storage capacitor Cs is discharged for charging the parasitic capacitor Cgd. Therefore, the node voltage N1 has a drop ΔVp1 from the first negative polarity driving voltage V₁₋.

As known, an common voltage VCOM, the driving voltages Vᵢ₊/Vᵢ₋ of the i-th gradient, the liquid crystal voltage V_{LCi} of the i-th gradient and the voltage drop ΔVpi of the i-th gradient satisfy the following expressions.

Vᵢ₊=VCOM+V_{LCi}+ΔVpi (1)

Vᵢ₋=VCOM−V_{LCi}+ΔVpi (2)

When the gray scale signal is of 6 bits, i is an integer between 1˜64.

From the equations (1) and (2), the following equations are obtained.

V₁₊=VCOM+V_{LC1}+ΔVp1 (3)

V₁₋=VCOM−V_{LC1}+ΔVp1 (4)

V₆₄₊=VCOM+V_{LC64}+ΔVp64 (5)

V₆₄₋=VCOM−V_{LC64}+ΔVp64 (6)

V₁₊−V₆₄₊=V_{LC1}−V_{LC64}+(ΔVp1−ΔVp64) (7)

V₆₄₋−V₁₋=V_{LC1-}V_{LC}64−(ΔVp1−ΔVp64) (8)

From the equations (7) and (8), it is known that (V₁₊−V₆₄₊) is not equal to (V₆₄₋−V₁₋). In other words, if at each gradient, the resistance value of the positive polarity resistor is the same as that of the negative polarity resistor, then the positive polarity driving voltages and the negative polarity driving voltages are not in symmetric. Therefore, in the embodiment, in each gradient, the resistance value of the positive polarity resistor is different from that of the negative polarity resistor for a better symmetry between the positive polarity driving voltages and the negative polarity driving voltages.

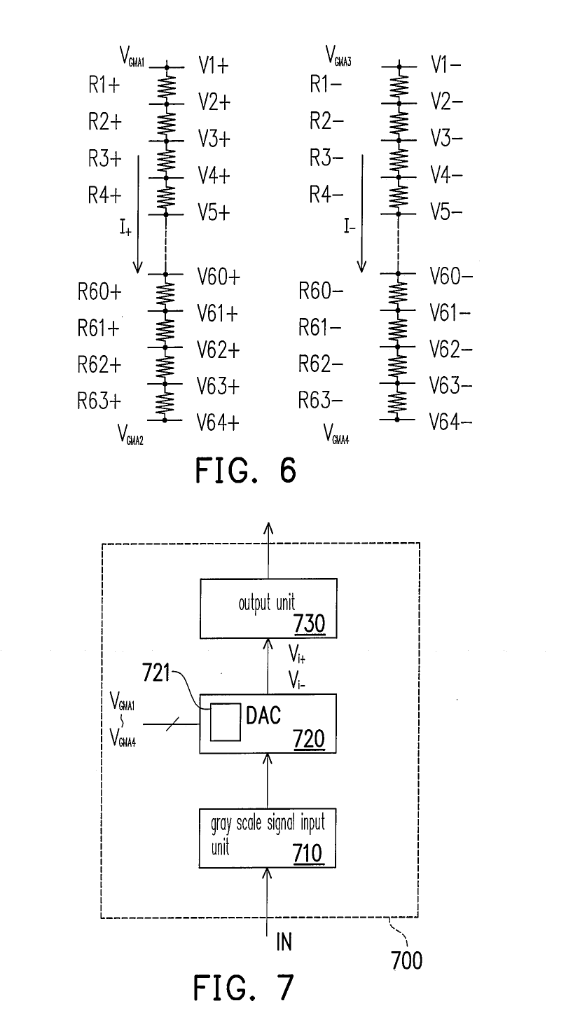

Now please refer to FIG. 6 which shows positive polarity resistors and negative polarity resistors according to the embodiment of the present invention. In FIG. 6, voltages V₁₊˜V₆₄₊ refer to the positive polarity driving voltages and voltages V₁₋˜V₆₄₋ refer to the negative polarity driving voltages. Currents I₊ and I− refers to currents flowing through the positive polarity resistors and the negative polarity resistors. V_{GMA1} and V_{GMA2} refer to externally controlled positive polarity reference voltages; and V_{GMA3} and V_{GMA4} refer to externally controlled negative polarity reference voltages. The positive polarity driving voltages V₁₊˜V₆₄₊+ are estimated by interpolating the positive polarity reference voltages V_{GMA1} and V_{GMA2}. Similarly, the negative polarity driving voltages V₁₋˜V₆₄₋ are estimated by interpolating the negative polarity reference voltages V_{GMA3} and V_{GMA4}. In FIG. 6, it is assumed that the first positive polarity driving voltage V₁₊ and the 64^{th} positive polarity driving voltage V₆₄₊ is set as the positive polarity reference voltages V_{GMA1} and V_{GMA2}, respectively. So, the resistance values of the positive polarity resistors R₁₊˜R₆₃₊ are expressed by:

R₁₊=(V₁₊−V₂₊)/I₊

R₂₊=(V₂₊−V₃₊)/I₊

. . .

R₆₃₊=(V₆₃₊−V₆₄₊)/I₊

Similarly, if it is assumed that the first negative polarity driving voltage V₁₋ and the 64^{th} negative polarity driving voltage V₆₄₋ are set as the negative polarity reference voltages V_{GMA3} and V_{GMA4}, respectively, the resistance values of the negative polarity resistors R₁₋˜R₆₃₋ are expressed by:

R₁₋=(V₁₋−V₂₋)/I−

R₂₋=(V₂₋−V₃₋)/I−

. . .

R₆₃₋=(V₆₃₋−V₆₄₋)/I−

It is known that the resistance value of the i-th positive polarity resistor Rᵢ₊ is different from the resistance value of the i-th negative polarity resistor Rᵢ₋. Even if no more than four reference voltages are applied, a better symmetry between the positive polarity driving voltages and the negative polarity driving voltages is achieved.

Now please refer to FIG. 7 which shows a block diagram of a source driving circuit according to the embodiment of the present invention. The source driving circuit 700 includes a gray scale input unit 710, a DAC unit 720 and an output unit 730. In the following, a gray scale signal of 6 bits is exemplary. The gray scale input unit 710 receives a gray scale signal IN. The DAC unit 720 receives an output signal from the gray scale input unit 710 and converts into one of the positive polarity driving voltages V₁₊˜V₆₄₊ and one of the negative polarity driving voltages V₁₋˜V₆₄₋. The DAC unit 720 estimates the positive polarity driving voltages V₁₊˜V₆₄₊ and the negative polarity driving voltages V₁₋˜V₆₄₋ based on positive polarity reference voltages V_{GMA1}/V_{GMA2} and negative polarity reference voltages V_{GMA3}/V_{GMA4}, respectively. The DAC unit 720 includes a resistor string 721. The resistor string 721 includes series connected positive polarity resistors R₁₊˜R₆₃₊ and series connected negative polarity resistors R₁₋˜R₆₃₋

The output unit 730 receives the positive polarity driving voltage Vᵢ₊ and the negative polarity driving voltage Vᵢ₋ from the DAC unit 720 for driving a display panel.

The embodiment of the invention provides a DAC and a source driving circuit using the same for generating symmetric positive polarity driving voltages and negative polarity driving voltages and improving the Gamma curve by positive polarity resistors and negative polarity resistors with different resistance values. The embodiment also provides a method for driving a display device by symmetric positive polarity driving voltages and negative polarity driving voltages.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A digital-to-analog conversion (DAC) circuit, receiving at least first and second positive polarity reference voltages and first and second negative polarity reference voltages, estimating first to N-th (N being a natural number) positive polarity driving voltages based on the first and second positive polarity reference voltages and estimating first to N-th negative polarity driving voltages based on the first and second negative polarity reference voltages, the DAC circuit comprising:
a positive polarity resistor string, having series connected first to (N−1)-th positive polarity resistors, the resistance value of the i-th (1≦i≦N−1) positive polarity resistor being corresponding to a difference between the i-th positive polarity driving voltage and the (i+1)-th positive polarity driving voltage; and
a negative polarity resistor string, having series connected first to (N−1)-th negative polarity resistors, the resistance value of the i-th negative polarity resistor being corresponding to a difference between the i-th negative polarity driving voltage and the (i+1)-th negative polarity driving voltage;
wherein the resistance value of the i-th positive polarity resistor is different from that of the i-th negative polarity resistor.

2. The DAC circuit of claim 1, wherein if the first positive polarity driving voltage is set as the first positive polarity reference voltage and the second positive polarity driving voltage is set as the second positive polarity reference voltage, the resistance value of the i-th positive polarity resistor is expressed as:
Rᵢ₊=(Vᵢ₊−V₍ᵢ₊₁₎₊)/I₊
wherein Rᵢ₊ refers to the resistance value of the i-th positive polarity resistor, Vᵢ₊ refers to the i-th positive polarity driving voltage, V₍ᵢ₊₁₎₊ refers to the (i+1)-th positive polarity driving voltage and I₊ refers to a current flowing through the positive polarity resistor string.

3. The DAC circuit of claim 1, wherein if the first negative polarity driving voltage is set as the first negative polarity reference voltage and the second negative polarity driving voltage is set as the second negative polarity reference voltage, the resistance value of the i-th negative polarity resistor is expressed as:
Rᵢ₋(V₁₋−V₍ᵢ₊₁₎₋)/I−
wherein Rᵢ₋ refers to the resistance value of the i-th negative polarity resistor, Vᵢ₋ refers to the i-th negative polarity driving voltage, V₍ᵢ₊₁₎₋ refers to the (i+1)-th negative polarity driving voltage and I− refers to a current flowing through the negative polarity resistor string.

4. A source driving circuit for driving a display device, the source driving circuit including:
a gray scale signal input unit, receiving a gray scale signal;
a digital-to-analog conversion unit, receiving an output signal from the gray scale input unit and converts into one of first to N-th (N being a natural number) positive polarity driving voltages and one of first to N-th negative polarity driving voltages, the DAC circuit estimating the first to N-th positive polarity driving voltages and the first to N-th negative polarity driving voltages based on first and second positive polarity reference voltages and first and second negative polarity reference voltages, respectively, the DAC unit including series connected first to (N−1)-th positive polarity resistors and series connected first to (N−1)-th negative polarity resistors, the i-th (i being a natural number between 1 and N−1) positive polarity resistor being coupled between the i-th positive polarity driving voltage and the (i+1)-th positive polarity driving voltage and the i-th negative polarity resistor being coupled between the i-th negative polarity driving voltage and the (i+1)-th negative polarity driving voltage, the resistance value of the i-th positive polarity resistor being different from that of the i-th negative polarity resistor; and
an output unit, receiving one of the first to N-th positive polarity driving voltages and one of the first to N-th negative polarity driving voltages from the DAC circuit.

5. The source driving circuit of claim 4, wherein if the first positive polarity driving voltage is set as the first positive polarity reference voltage and the second positive polarity driving voltage is set as the second positive polarity reference voltage, the resistance value of the i-th positive polarity resistor is expressed as:
Rᵢ₊=(Vᵢ₊−V₍ᵢ₊₁₎₊)/I₊
wherein Rᵢ₊ refers to the resistance value of the i-th positive polarity resistor, Vᵢ₊ refers to the i-th positive polarity driving voltage, V₍ᵢ₊₁₎₊ refers to the (i+1)-th positive polarity driving voltage and I₊ refers to a current flowing through the positive polarity resistors.

6. The source driving circuit of claim 4, wherein if the first negative polarity driving voltage is set as the first negative polarity reference voltage and the second negative polarity driving voltage is set as the second negative polarity reference voltage, the resistance value of the i-th negative polarity resistor is expressed as:
Rᵢ₋=(Vᵢ₋−V₍ᵢ₊₁₎₋)/I−
wherein Rᵢ₋ refers to the resistance value of the i-th negative polarity resistor, Vᵢ₋ refers to the i-th negative polarity driving voltage, V₍ᵢ₊₁₎₋ refers to the (i+1)-th negative polarity driving voltage and I− refers to a current flowing through the negative polarity resistors.

7. A method for driving a display device, comprising steps of:
receiving a gray scale signal;
estimating first to N-th (N being a natural number) positive polarity driving voltages based on first and second positive polarity reference voltages;
estimating first to N-th negative polarity driving voltages based on first and second negative polarity reference voltages;
calculating resistance values of first to (N−1)-th positive polarity resistors based on the estimated first to N-th positive polarity driving voltages, the i-th (i being a natural number between 1 and N−1) positive polarity resistor being coupled between the i-th positive polarity driving voltage and the (i+1)-th positive polarity driving voltage;
calculating resistance values of first to (N−1)-th negative polarity resistors based on the estimated first to N-th negative polarity driving voltages, the i-th negative polarity resistor being coupled between the i-th negative polarity driving voltage and the (i+1)-th negative polarity driving voltage, the resistance value of the i-th positive polarity resistor being different from that of the i-th negative polarity resistor; and
driving the display device based on one of the positive polarity driving voltages or one of the negative polarity driving voltages.
